(19) United States
(12) Patent Application Publication
(10) Pub. No.: US 2005/0117507 A1
(43) Pub. Date: Jun. 2, 2005

(54) Information storage medium and method and apparatus for reproducing information recorded on the same

(75) Inventors: In-oh Hwang, Gyeonggi-do (KR); In-sik Park, Gyeonggi-do (KR); Kyung-geun Lee, Gyeonggi-do (KR); Hyun-ki Kim, Gyeonggi-do (KR); Joo-ho Kim, Gyeonggi-do (KR)

Correspondence Address: STAAS & HALSEY LLP, SUITE 700, 1201 NEW YORK AVENUE, N.W., WASHINGTON, DC, 20005, US

(73) Assignee: Samsung Electronics Co., Ltd., Suwon-Si (KR)

(21) Appl. No.: 10/996,606

(22) Filed: Nov. 26, 2004

(30) Foreign Application Priority Data
Nov. 28, 2003 (KR) 2003-85774

(51) Int. Cl. G11B 7/24; G11B 5/09

(52) U.S. Cl. 369/275.4; 369/53.26; 369/116

(57) ABSTRACT

An information storage medium containing recording marks with a size below a resolution limit of an incident beam emitted from an information reproducing apparatus, the information storage medium including a reference signal, recorded in the form of data, to compensate for signal degradation due to defocus or tilt, and a method and apparatus to reproduce information from the information storage medium.

### CROSS-REFERENCE TO RELATED APPLICATIONS

This application claims the priority of Korean Patent Application No. 2003-85774, filed on Nov. 28, 2003, in the Korean Intellectual Property Office, the disclosure of which is incorporated herein in its entirety by reference.

### BACKGROUND OF THE INVENTION

1. Field of the Invention

The present invention relates to an information storage medium constructed to use a super-resolution phenomenon and a method and apparatus for reproducing information recorded on the same, and, more particularly, to an information storage medium constructed to reduce an impact of defocus or tilt, and a method of reproducing, and apparatus to reproduce, information recorded on the same.

2. Description of the Related Art

An information storage medium is widely used in an optical pickup system for non-contact type recording/reproducing. Since demands for high density recording have increased, research has been conducted to develop an information storage medium having recording marks smaller than the resolution limit of a laser beam which uses a super-resolution phenomenon.

An information storage medium employing the super-resolution phenomenon includes a mask layer in which surface plasmons are generated by an incident beam. Accordingly, high density recording can be achieved using the surface plasmons produced in the mask layer.

For example, in the case of using the mask layer made from platinum oxide (PtOₓ), when a laser beam hits the mask layer, PtOₓ forming the mask layer decomposes into Pt and oxygen (O₂). A near field is generated when surface plasmons are generated in the Pt. Thus, it is possible to reproduce a signal from recording marks with a size below the resolution limit of the laser beam focused onto the information storage medium by an objective lens.

Meanwhile, further study of the information storage medium employing the super-resolution phenomenon is needed to obtain a carrier-to-noise ration (CNR) required for signal reproduction and to prevent signal degradation due to repeated reproduction.

### SUMMARY OF THE INVENTION

The present invention provides an information storage medium constructed to obtain a carrier-to-noise ratio (CNR) required for signal reproduction and to increase a signal margin by reducing an impact of a defocus or tilt when reproducing a signal from a recording mark smaller than the resolution limit of a beam, and a method and apparatus to reproduce information recorded on the same.

Additional aspects and/or advantages of the invention will be set forth in part in the description which follows and, in part, will be obvious from the description, or may be learned by practice of the invention.

According to an aspect of the present invention, there is provided an information storage medium containing recording marks with a size below a resolution limit of an incident beam emitted from an information reproducing apparatus, the information storage medium comprising a reference signal, recorded in the form of data, to compensate for signal degradation due to defocus or tilt. Here, the reference signal may be used to determine whether a level of a reproduced signal detected by the information reproducing apparatus is higher than or equal to the level required for reproduction.

According to another aspect of the present invention, there is provided a method of reproducing a signal from an information storage medium containing recording marks with a size below the resolution limit of an incident beam emitted from an information reproducing apparatus. The method includes emitting a beam having a predetermined readout power onto the information storage medium; receiving the beam reflected from the information storage medium and detecting a reproduced signal of the information storage medium and a reference signal used to determine whether a level of the reproduced signal is higher than or equal to that required for reproduction; and determining whether the level of the detected reproduced signal is higher than or equal to that required for reproduction, and compensating for the level of the reproduce signal in response to the level being lower than the level required for reproduction.

According to still another aspect of the present invention, there is provided an information reproducing apparatus to reproduce a signal from an information storage medium having recording marks with a size below the resolution limit of an incident beam and a lead-in area, a data area, and a lead-out area, wherein a reference signal to compensate for defocus or tilt is recorded in the lead-in area and/or lead-out area in the form of data. The apparatus includes a pickup including a light source to emit a beam onto the information storage medium, and a photodetector to receive a beam reflected from the information storage medium and detect a reproduced signal and a reference signal; and a signal processor to determine whether a readout power level of a beam emitted from the light source is higher than or equal to a minimum readout power level required for reproduction based on the reference signal detected by the photodetector, wherein the signal processor adjusts the readout power of the light source in response to the readout power level of the beam being lower than the minimum readout power level required for reproduction.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 is a schematic cross-sectional view of a super-resolution information storage medium which may be used with the present invention;

FIG. 2 is a graph showing changes in CNR with respect to a readout power for 75 nm and 300 nm recording marks;

FIG. 3 is a graph showing a change in peak value of normalized luminous intensity with respect to tilt angle in the information storage medium of FIG. 1;

FIG. 4 is a graph showing the ratio of a beam spot diameter in the presence of tilt to that in the absence of tilt in the information storage medium of FIG. 1;

FIG. 5 is a graph showing a change in peak luminous intensity with respect to the amount of defocus in the information storage medium of FIG. 1;

FIG. 6 is a graph showing the ratio of a beam spot diameter in the presence of defocus to that in the absence of defocus in the information storage medium of FIG. 1;

FIG. 7 is a schematic cross-sectional view of an information storage medium used to examine a change in optical characteristics with respect to a readout power according to an embodiment of the present invention;

FIG. 8 is a graph showing changes in CNR with respect to the amount of defocus for 75 nm and 300 nm recording marks;

FIGS. 9 and 10 are graphs showing a change in CNR with respect to tangential tilt and radial tilt for 75 nm and 300 nm recording marks in the information storage medium of FIG. 7, respectively;

FIGS. 11-13 are graphs showing changes in CNR with respect to the amount of defocus, tangential tilt, and radial tilt, respectively, which are measured at different readout powers for a 75 nm recording mark size below the resolution limit in the information storage medium of FIG. 7;

FIG. 14 illustrates the layout of each area in an information storage medium according to an embodiment of the present invention;

FIG. 15 illustrates the detailed layout of a disc control test zone shown in FIG. 14;

FIG. 16 is a schematic diagram of an apparatus to reproduce information from an information storage medium according to an embodiment of the present invention; and

FIG. 17 is a flowchart illustrating a method of reproducing information from an information storage medium according to an embodiment of the present invention.

### DETAILED DESCRIPTION OF THE PREFERRED EMBODIMENTS

Reference will now be made in detail to the embodiments of the present invention, examples of which are illustrated in the accompanying drawings, wherein like reference numerals refer to the like elements throughout. The embodiments are described below to explain the present invention by referring to the figures.

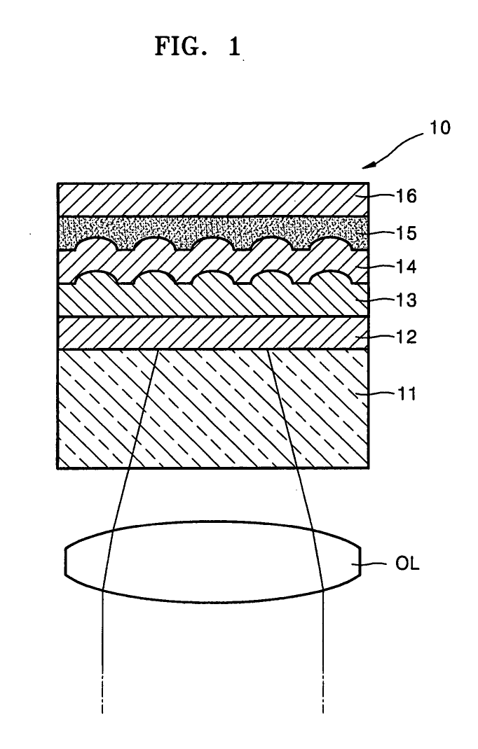

Prior to describing some of the possible embodiments of the present invention, a super-resolution optical recording medium constructed as shown in FIG. 1, for which a patent application was filed with the Korean Intellectual Property Office on Oct. 2, 2003 under Korean Patent Application No. 2003-75635, will be described in detail. Referring to FIG. 1, the information storage medium 10 using a super-resolution phenomenon includes a substrate 11 having a first dielectric layer 12, a recording layer 13, a second dielectric layer 14, a recording auxiliary layer 15, and a third dielectric layer 16 sequentially formed over the surface of the substrate 11. Here, the recording layer 13 comprises a metal oxide such as platinum oxide, and the recording auxiliary layer 15 comprises a phase-change material.

When a laser beam is emitted on the recording layer 13, platinum oxide forming a mask layer is decomposed into platinum, which generates surface plasmons, and oxygen. A near field is generated when surface plasmons are generated in the platinum. Thus, it is possible to reproduce a signal from recording marks with a size below the resolution limit of the laser beam that is focused onto the information storage medium by an objective lens OL. For example, if the resolution limit of an optical pickup is 119 nm, 75 nm recording marks, which are smaller than the resolution limit of 119 nm, can be successfully reproduced.

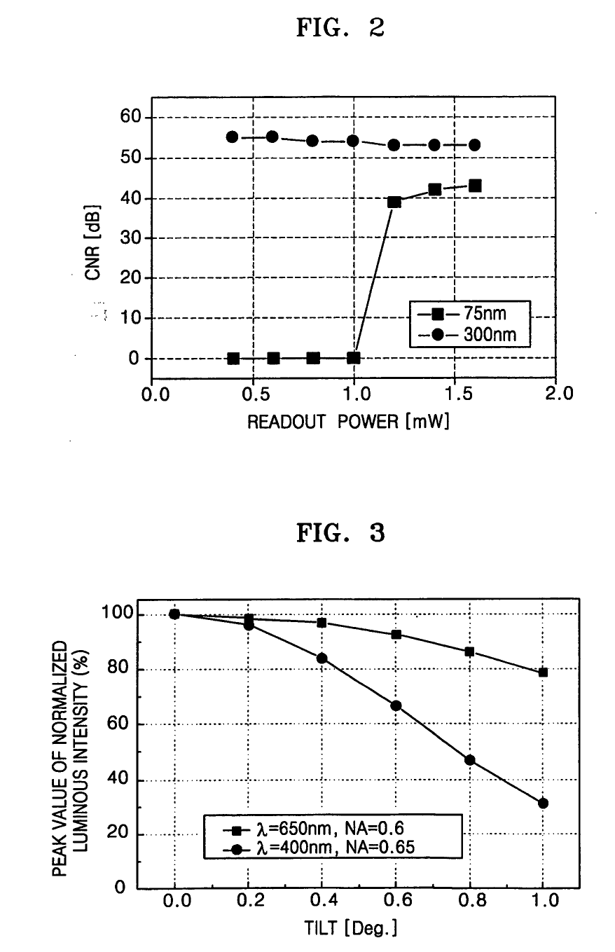

To reproduce recording marks smaller than the resolution limit of an optical pickup in the information storage medium using the super-resolution phenomenon, a readout power greater than one ordinarily used is required. FIG. 2 shows changes in carrier-to-noise ratio (CNR) with respect to a readout power for 75 nm and 300 nm recording marks when an optical pickup with the resolution limit of 119 nm, including a light source that emits a beam with a wavelength of 405 nm and an objective lens with numerical aperture (NA) of 0.85, is used. Referring to FIG. 2, while a CNR is 50 dB or more even at a readout power less than 1.0 mW for a 300 nm recording mark, a stable CNR of 40 dB or more can be obtained for a 75 nm recording mark only when a readout power is about 1.2 mW or higher. That is, for the 75 nm recording mark, the CNR required for reproduction cannot be obtained at a low readout power. This is because a super-resolution effect can be created only when the amount of an incident beam is greater than a predetermined amount, or the temperature within the information storage medium rises above a predetermined value.

Meanwhile, in an apparatus to reproduce information from the information storage medium, when focusing failure occurs, or a laser beam incident on the information storage medium is tilted away from the recording surface so as not to be normal to the recording surface, the size of a beam spot created on the information storage medium increases, and therefore its energy density decreases. Thus, the CNR may decrease since the amount of beam is reduced. These phenomena will now be described in detail with references to FIGS. 3-6.

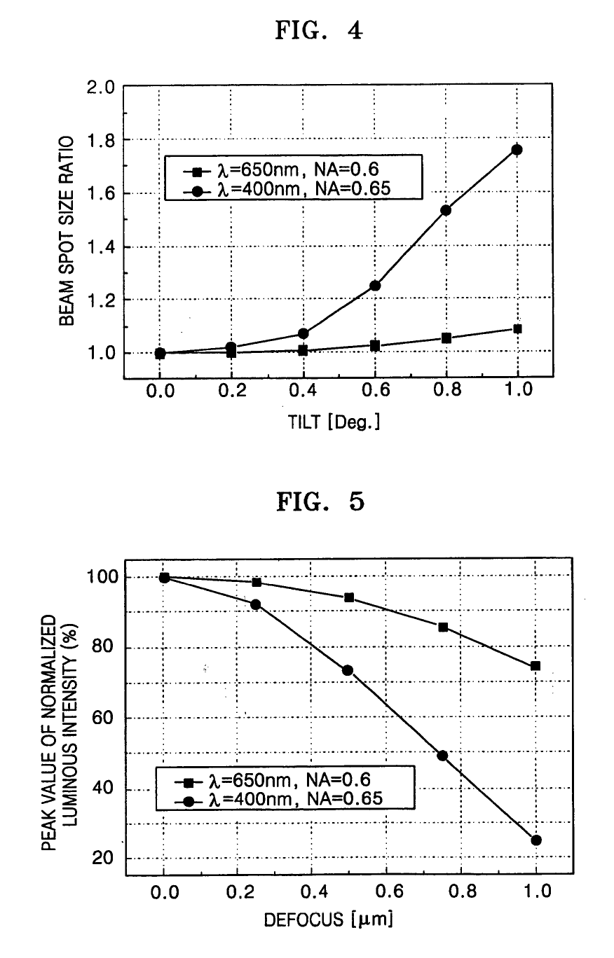

FIG. 3 shows changes in peak value of normalized luminous intensity with respect to tilt angle on the information storage medium of FIG. 1, and FIG. 4 shows the ratio of a beam spot diameter in the presence of tilt to that in the absence of tilt. Here, comparison is made between two groups using an optical pickup, one group having a light source that emits a beam with a wavelength of 400 nm and an objective lens with an NA of 0.6, and the other group having a light source that emits a beam with a wavelength of 650 nm and an objective lens with an NA of 0.65. In FIG. 3, despite the difference in wavelength of the beams, both groups show that peak luminous intensity decreases as a tilt angle increases. As is evident from FIG. 4, in the case of the beam with a 400 nm wavelength, a beam spot diameter at a tilt angle of 1 degree is 1.76 times larger than that in absence of tilt. In the case of the beam with a 650 nm wavelength, the former is 1.08 times larger than the latter.

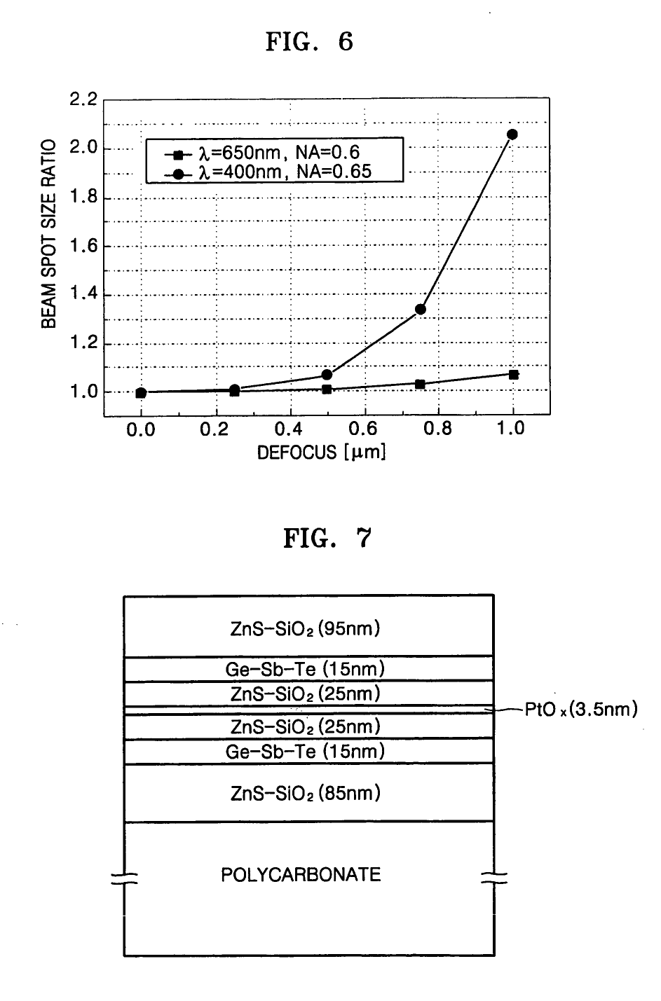

FIG. 5 shows changes in peak luminous intensity with respect to the amount of defocus on the information storage medium of FIG. 1, and FIG. 6 shows the ratio of a beam spot diameter when the beam is focused to that when the beam is defocused on the information storage medium of FIG. 1. Here, comparison is made between two groups using optical pickups, one group having a light source that emits a beam with a wavelength of 400 nm and an objective lens with an NA of 0.6, and the other group having a light source that emits a beam with a wavelength of 650 nm and an objective lens with an NA of 0.65. In FIG. 5, despite the difference in wavelength of the beams used, both groups show that peak luminous intensity decreases as the amount of defocus increases. As is evident from FIG. 6, in the case of the beam with 400 nm wavelength, a beam spot diameter significantly increases as the amount of defocus increases compared to when the beam is focused. Thus, the information storage medium of FIG. 1 has a problem such that the amount of light is reduced since energy density decreases as the amount of tilt or defocus increases, even when the same readout power is applied for reproduction.

Thus, the present invention provides a method of increasing defocus and tilt margins, which is not considered in the information medium described above.

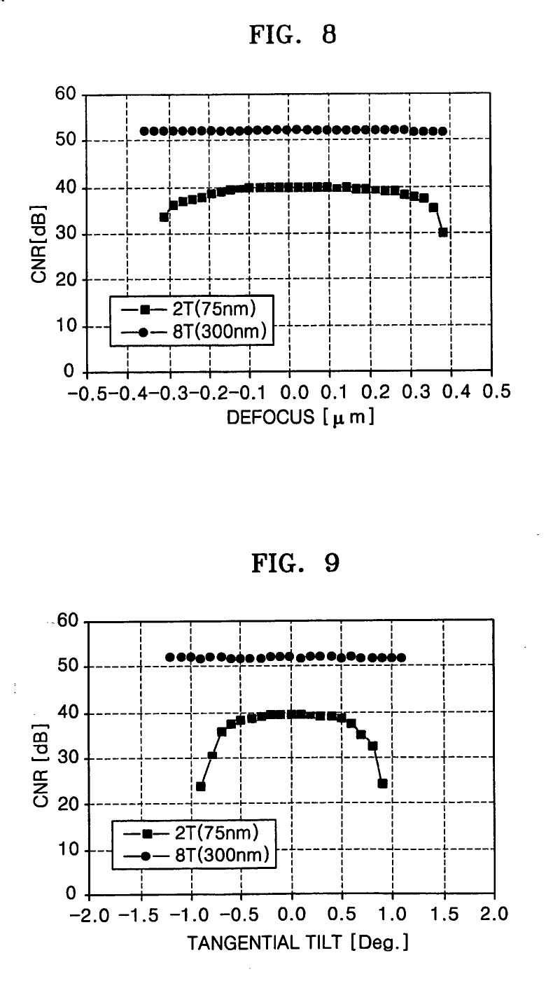

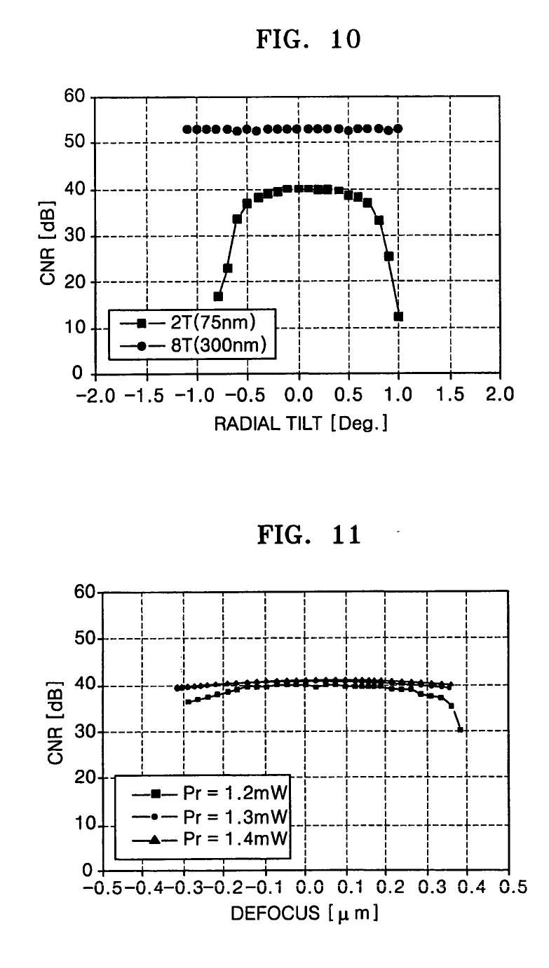

One embodiment of the present invention, in which this and/or other aspects are achieved, is, an information storage medium constructed as shown in FIG. 7. FIGS. 8-13 show test results obtained using the information storage medium of FIG. 7.

Referring to FIG. 7, the information storage medium includes a polycarbonate substrate having several layers sequentially formed over the surface by a process such as sputtering. The several layers are a ZnS—SiO₂ dielectric layer with a thickness of approximately 85 nm, a Ge—Sb—Te recording auxiliary layer with a thickness of approximately 15 nm, a ZnS—SiO₂ dielectric layer with a thickness of approximately 25 nm, a PtOₓ metal oxide recording layer with a thickness of approximately 3.5 nm, a ZnS—SiO₂ dielectric layer with a thickness of approximately 25 nm, a Ge—Sb—Te recording auxiliary layer with a thickness of approximately 15 nm, and a ZnS—SiO₂ dielectric layer with a thickness of approximately 95 nm.

In an apparatus having an optical pickup using this embodiment of the information storage medium, a beam incident on the information storage medium may undergo defocusing, or an optical axis of the incident beam may be tilted away from the recording surface so as not to be normal to the recording surface of the information storage medium. The impact of such defocusing or tilt will now be described.

FIGS. 8-10 show changes in CNR with respect to the amount of defocus, tangential tilt, and radial tilt, respectively, on the super-resolution information storage medium of FIG. 7. More specifically, changes in CNR relative to the amount of defocus and tangential and radial tilt were measured for 2T (mark length of 75 nm) and 8T (mark length of 300 nm) pulses at a readout power of 1.2 mW when a run length limit (RLL) (1,7) modulation code is used. Here, the RLL is a modulation technique that limits the number of consecutive 0's between the successive 1's. RLL (d,k) indicates that the sequence of 0's ranges from d to k.

Referring to FIGS. 8-10, the CNR is about 50 dB without being affected by the amount of defocus and tilt for the 8T mark length, which is longer than the resolution limit of the optical pickup. In contrast, for the 2T mark length, which is shorter than the resolution limit, the CNR decreases to below 40 dB when the amount of defocus deviates from the range of plus-or-minus 0.2 μm. The CNR is also reduced to significantly less than 40 dB when the amount of tilt deviates outside the range of plus-or-minus 0.5 degrees. This is because the energy density of the incident beam per unit area decreases due to the presence of defocus or tilt, thus attenuating a super-resolution effect. Thus, in the information storage medium of FIG. 7, it is possible in principle to reproduce a signal at a readout power higher than 1.2 mW. However, since CNR is sensitive to changes in the amount of defocus and tilt, a signal margin significantly decreases.

FIGS. 11-13 show changes in CNR with respect to the amount of defocus, tangential tilt, and radial tilt, respectively, which are measured at different readout powers for a recording mark with a size of 75 nm, which is below the resolution limit in the information storage medium of FIG. 7. Here, the information storage medium rotates at a linear velocity of 5 m/sec, and the measurements were made at readout powers of 1.2, 1.3, and 1.4 mW, respectively.

As is evident from FIG. 11, when the amount of defocus deviates outside the range of plus-or-minus 0.3 μm, the CNR decreases to below 40 dB at a readout power Pr of 1.2 mW, while the CNR remains at approximately the same level of 40 dB at a readout power Pr between 1.3 and 1.4 mW.

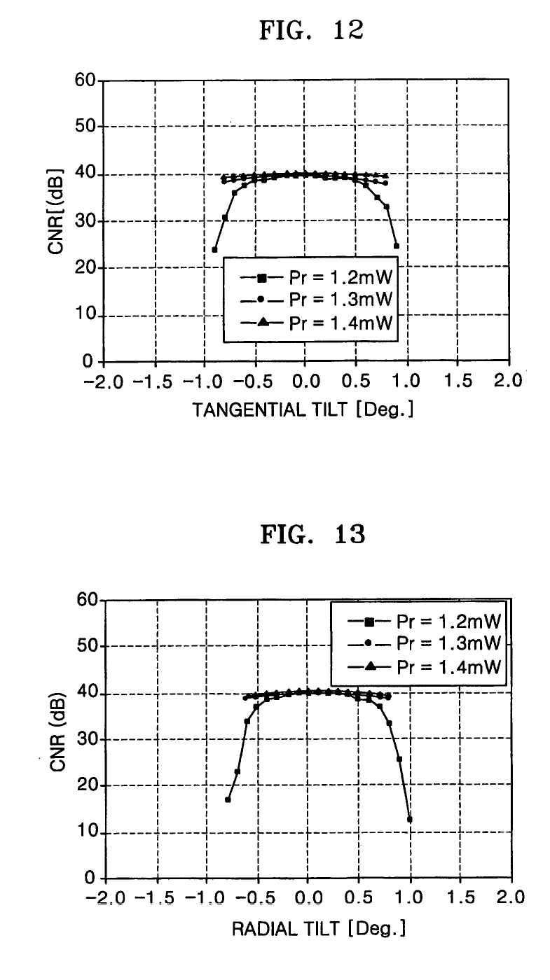

As is evident from FIGS. 12 and 13, the CNR falls significantly below 40 dB at a readout power Pr of 1.2 mW when the tangential and radial tilt deviates by ±0.5 degrees, while the CNR is maintained at approximately 40 dB at a readout power Pr between 1.3 and 1.4 mW, even when the tangential and radial tilt deviates by ±0.7 degrees. Thus, when the CNR decreases to less than 90% of a CNR range required for reproduction due to the presence of the defocus or tilt, it is possible to compensate for decreased energy density per unit area by raising the readout power based on a reference signal stored in the information storage medium, and thus restore the required CNR. Thus, tolerances to defocus and tilt on the information storage medium can be increased.

Thus, an information storage medium according to an embodiment of the present invention includes recording marks with a size below the resolution limit of an incident beam to allow recording/reproduction of information using a super-resolution phenomenon. The information storage medium further includes a reference signal in order to increase defocus and tilt tolerances.

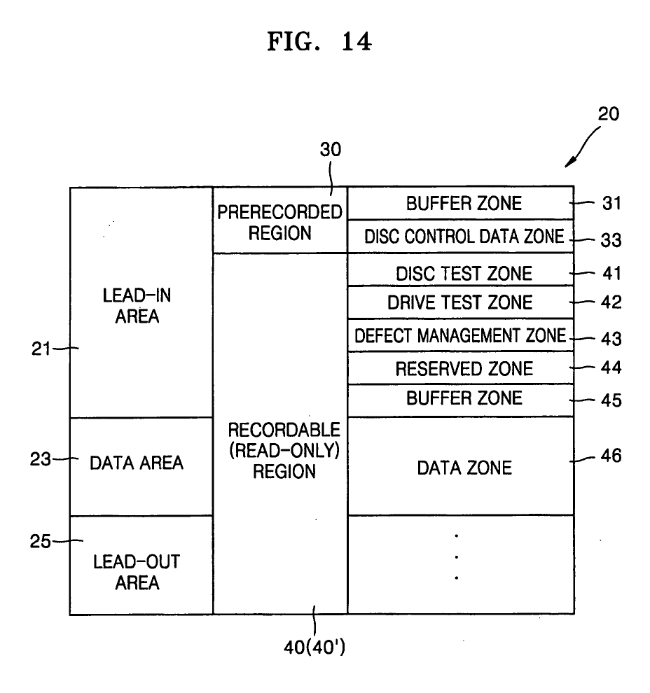

Referring to FIG. 14, an information storage medium 20 according to an embodiment of the present invention includes a data area 23 containing user data, a lead-in area 21 located at the inner circumference of the data area 23, and a lead-out area 25 located at the outer circumference of the data area 23. Here, predetermined data (to be described later) is prerecorded in at least a portion of the lead-in area 21, which is used as a prerecorded region 30 on which the recorded data is permanently stored. The remaining portion of the lead-in area 21, the data area 23, and the lead-out area 25 are used as a recordable region 40.

When the information storage medium 20 is used as a write-once or rewritable disc, user data is recorded on the recordable region 40. When the information storage medium 20 is used as a read-only disc, the remaining portion of the lead-in area 21, the data area 23, and the lead-out area 25 are used as a read-only region 40′ instead of the recordable region 40.

The prerecorded region 30 includes a buffer zone 31 and a disc control data zone 33 containing disc related information and copy protection information. The recordable region 40 includes a disc test zone 41, a drive test zone 42, a defect management zone 43, a reserved zone 44, a buffer zone 45, and a data zone 46.

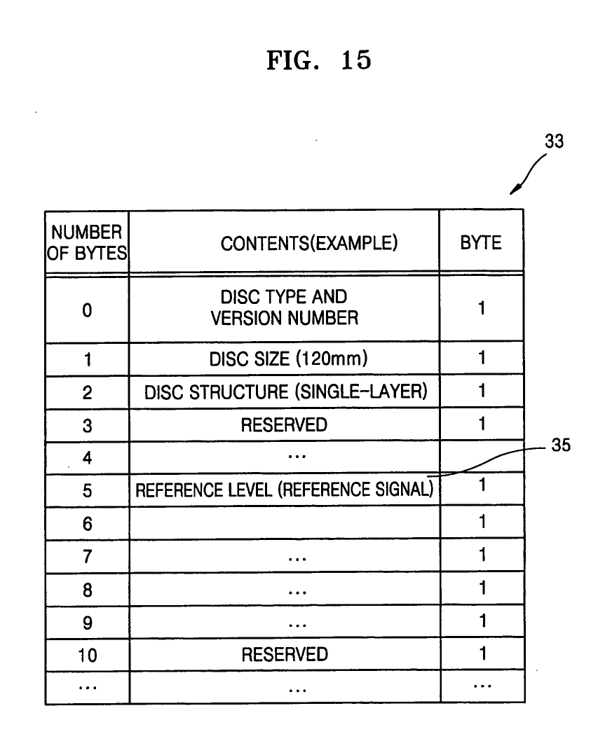

As shown in FIG. 15, the disc control data zone 33 contains disc related information, reserved zones, and a reference level 35. Here, the disc related information includes, for example, the type and version number of the information storage medium (e.g., recordable, write-once, or read-only), a disc size (e.g., diameter 120 mm), a disc structure (e.g., single-layer structure), and recording speed.

The reference level 35 is a zone in which a reference signal is recorded in the form of data to compensate for signal degradation due to defocus or tilt of the information storage medium 20. Preferably, though not necessarily, the reference signal may be recorded in the form of a recording mark with a size larger than the resolution limit of an incident beam so that it can also be reproduced by a general optical pickup having a lower readout power than a super-resolution optical pickup. The recording marks may be recorded in the form of wobbles or pre-pits. The reference signal may also be recorded in super-resolution recording marks that can be read at a high readout power (e.g. 1.2 mW or higher) needed for super-resolution reproduction.

The reference signal is used to determine whether a signal detected by an apparatus to reproduce information, which will be described below, has a level higher than or equal to that required for reproduction. In other words, the reference signal represents a signal that can be reproduced when detecting a signal through an apparatus to reproduce information, and is prerecorded in the form of data using an RLL modulation code. Here, the reference signal is recorded as the highest or lowest level among a plurality of levels required for reproduction, a difference in amplitude between the high and low signal levels, or reflectivity. Although the reference signal has been recorded on the disc control data zone 33 in the illustrative embodiment, the scope of the present invention is not limited thereto. That is, the reference signal may be recorded on either another zone of the lead-in area 21, or the lead-out area 25, or both.

An information reproducing apparatus to reproduce, and a method of reproducing, a signal from an information storage medium on which the reference signal is recorded according to embodiments of the present invention will now be described in detail.

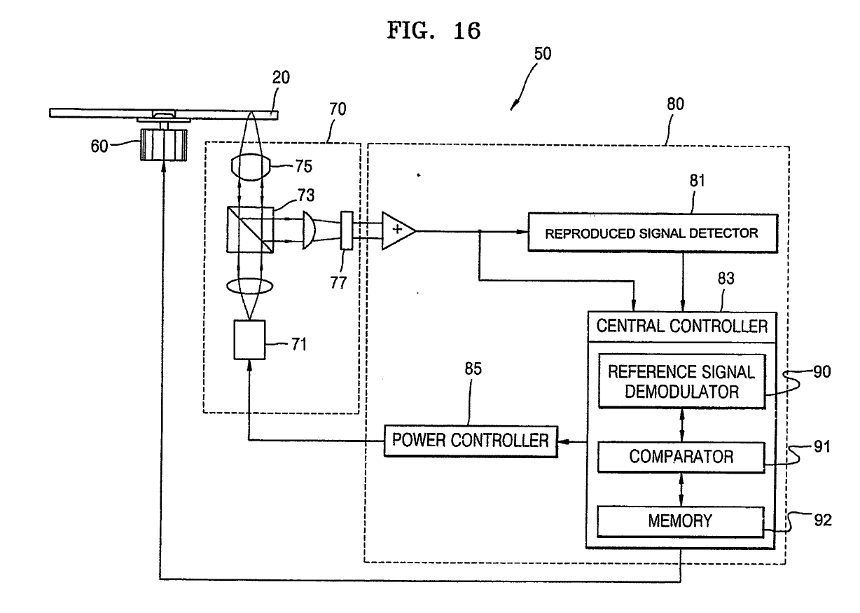

FIG. 16 schematically shows an information storage medium 20 and an information reproducing apparatus 50 according to embodiments of the present invention. Referring to FIG. 16, the information reproducing apparatus 50 includes a driver 60 to rotate the information storage medium 20, a pickup 70 to read a reproduced signal from the information storage medium 20, and a signal processor 80 to process the read signal. The pickup 70 includes a light source 71 to emit a beam having a predetermined power and a wavelength, a beam splitter 73 to convert the propagation path of the beam, an objective lens 75 to focus the beam on the information storage medium 20, and a photodetector 77 to receive the beam reflected from the information storage medium 20 and detect a reproduced signal and a reference signal.

The signal processor 80 determines whether the readout power level of a beam emitted from the light source 71 is higher than or equal to that required for reproduction based on the reference signal detected by the photodetector 77, and, if it is lower than required, adjusts the readout power of the light source 71. In addition, the signal processor 80 controls the driver 60 such that it rotates at predetermined linear velocity, e.g., 5 m/sec.

To achieve these functions, the signal processor 80 includes a reproduced signal detector 81 to detect the level of an actually reproduced signal read through the photodetector 77, a central controller 83, and a power controller 85 to adjust the readout power of the light source 71. The central controller 83 includes a reference signal demodulator 90, a comparator 91, and a memory 92. The reference signal demodulator 90 demodulates the reference signal to obtain information on a signal range in which reproduction is possible. The memory 92 stores the same information, and the comparator 91 compares the stored information with a reproduced signal detected from the reproduced signal detector 81 in order to determine whether the level of the detected reproduced signal satisfies the signal range in which reproduction is possible.

Here, the detected reproduced signal varies depending on the amount of defocus, tangential tilt, or radial tilt of the information storage medium 20. It cannot be exactly known whether the level of the reproduced signal is determined due to the defocus or the tilt. However, regardless of which of these determines the level of the reproduced signal, degradation of the reproduced signal can be solved by increasing the readout power. In contrast to the reproduced signal, the reference signal is not affected by the position of the information storage medium 20.

When the reproduced signal is in the signal range where reproduction is possible, the central controller 83 controls the output power of the beam emitted from the light source 71 through the power controller 85 such that reproduction is performed at an initial readout power. Conversely, when the reproduced signal is not in the signal range where reproduction is possible, the central controller 83 progressively increases the readout power such that the reproduced signal reaches the range where reproduction is possible based on changes in CNR with respect to a readout power as explained with references to FIGS. 11-13. An information reproducing method of reproducing a signal from an information storage medium including recording marks with a size below the resolution limit of an incident beam through the information reproducing apparatus 50 will now be described in detail.

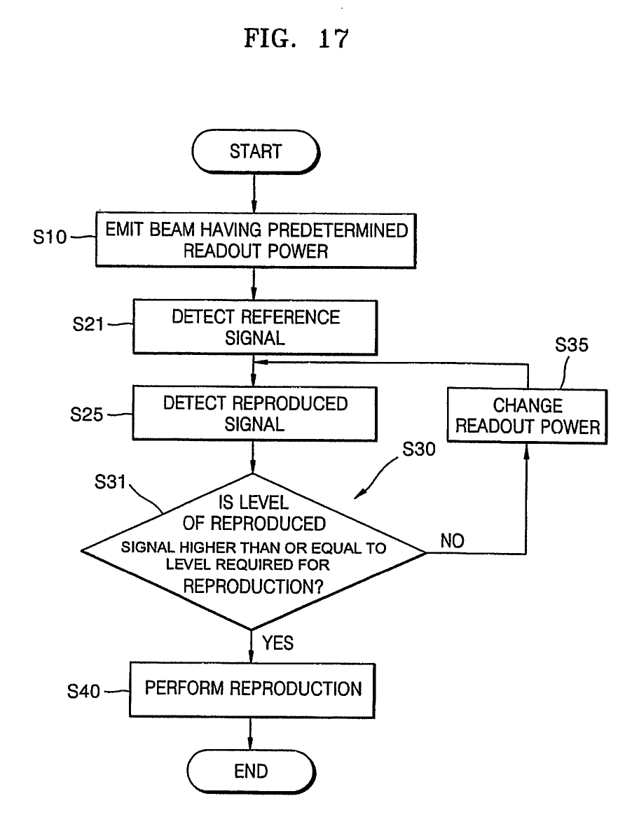

Referring to FIGS. 16 and 17, in operation S10, a beam having a predetermined readout power is emitted on the rotating information storage medium 20. On the information storage medium 20, a reference signal is recorded in the form of data.

In operations S21 and S25, the beam reflected from the information storage medium 20 is received by the photodetector 77 in order to detect a reference signal and a reproduced signal. Here, the reproduced signal varies depending on the amount of defocus, which is a deviation of a beam spot from a focal point, and the amount of tilt along tangential or radial direction. The reference signal is used to determine whether the reproduced signal has a minimum reproduction quality, and the determination may be made by comparing the reference signal and the reproduced signal on the basis of signal level, signal amplitude, or reflectivity. In operation S31, it is determined whether the detected reproduced signal has a level higher than or equal to that required for reproduction based on the reference signal, and if the level of the reproduced signal is lower than required, in operation S30, the level is adjusted by changing or increasing the readout power of the light source 71 in operation S35. After adjusting the level and repeating operations S25-S30, the reproduced signal has a level required for reproduction, and then normal reproduction is performed in operation S40.

The information storage medium according to the present invention allows information to be reproduced from recording marks with a size below a resolution limit of a laser beam used to reproduce the information, thereby increasing the recording density and thus storage capacity, which is also possible by using a short wavelength laser diode or higher NA objective lens. In addition, the information storage medium includes a reference signal used to adjust the readout power, thus increasing tolerances on defocus and tilt of the information storage medium with respect to an information reproducing apparatus.

Furthermore, in an information reproducing apparatus and method according to the present invention, a readout power is adjusted after comparing the reference signal recorded on the information storage medium and the reproduced signal, thereby reducing the influence of defocus and tilt and increasing a signal margin.

Although a few embodiments of the present invention have been shown and described, it would be appreciated by those skilled in the art that changes may be made in these embodiments without departing from the principles and spirit of the invention, the scope of which is defined in the claims and their equivalents.

1. An information storage medium containing recording marks with a size below a resolution limit of an incident beam emitted from an information reproducing apparatus, the information storage medium comprising a reference signal, recorded in the form of data, to compensate for signal degradation due to defocus or tilt.

2. The information storage medium of claim 1, wherein the reference signal is used to determine whether a level of a reproduced signal detected by the information reproducing apparatus is higher than or equal to a level required for reproduction.

3. The information storage medium of claim 1, wherein the information storage medium comprises a lead-in area, a data area, and a lead-out area, and the reference signal is recorded in the lead-in area and/or the lead-out area.

4. The information storage medium of claim 3, wherein at least a portion of the lead-in area is a read-only region on which recorded data is permanently stored.

5. The information storage medium of claim 1, wherein the reference signal is compared to a reproduced signal in the information reproducing apparatus to determine whether the reproduced signal has a minimum reproduction quality.

6. The information storage medium of claim 5, wherein the determination may be made by comparing the reference signal and the reproduced signal on the basis of signal level, signal amplitude, or reflectivity.

7. A method of reproducing a signal from an information storage medium containing recording marks with a size below the resolution limit of an incident beam emitted from an information reproducing apparatus, the method comprising:
emitting a beam having a predetermined readout power onto the information storage medium;
receiving the beam reflected from the information storage medium and detecting a reproduced signal of the information storage medium and a reference signal used to determine whether a level of the reproduced signal is higher than or equal to a level required for reproduction; and
determining whether the level of the detected reproduced signal is higher than or equal to the level required for reproduction, and compensating for the level of the reproduced signal in response to the level being lower than the level required for reproduction.

8. The method of claim 7, wherein the information storage medium comprises a lead-in area, a data area, and a lead-out area, and the reference signal is recorded on the lead-in area and/or the lead-out area in the form of data.

9. The method of claim 8, wherein the reference signal is used to compensate for defocus of the emitted beam or tilt of the information storage medium.

10. The method of claim 7, wherein, after comparing the detected reference signal and reproduced signal, the power of the emitted beam is increased in response to the reproduced signal being lower than the level required for reproduction so that the level of the reproduced signal is higher than or equal to the level required for reproduction.

11. An information reproducing apparatus to reproduce a signal from an information storage medium having recording marks of a size below the resolution limit of an incident beam and a lead-in area, a data area, and a lead-out area, wherein a reference signal to compensate for defocus or tilt is recorded in the lead-in area and/or lead-out area in the form of data, the apparatus comprising:
a pickup comprising:
a light source to emit a beam onto the information storage medium, and
a photodetector to receive the beam reflected from the information storage medium and detect a reproduced signal and a reference signal; and
a signal processor to determine whether a readout power level of the beam emitted from the light source is higher than or equal to a minimum readout power required for reproduction based on the reference signal detected by the photodetector;
wherein the signal processor adjusts the readout power of the light source in response to the readout power level of the beam being lower than the minimum readout power required for reproduction.

12. The information reproducing apparatus of claim 11, wherein the signal processor comprises:
a reference signal demodulator to demodulate the reference signal to determine the minimum readout power required for reproduction;
a memory to store the minimum readout power; and
a comparator to compare the stored information with the reproduced signal to determine whether the readout power of the light source is higher than or equal to the minimum readout power required for reproduction.

13. An information storage medium having recording marks smaller than a resolution limit of an incident beam emitted from an information reproducing apparatus, the information storage medium comprising:
a reference signal recorded in the form of data;
wherein the reference signal is used by the information reproducing apparatus to determine whether a reproduced signal read from the information storage medium has a minimum reproduction quality.

14. The information storage medium of claim 13, wherein the information storage medium is formed of sequential layers comprising:
a first ZnS—SiO₂ layer with a thickness of approximately 85 nm;
a first Ge—Sb—Te layer with a thickness of approximately 15 nm;
a second ZnS—SiO₂ layer with a thickness of approximately 25 nm;
a PtOₓ metal oxide layer with a thickness of approximately 3.5 nm;
a third ZnS—SiO₂ layer with a thickness of approximately 25 nm;
a second Ge—Sb—Te layer with a thickness of approximately 15 nm; and
a fourth ZnS—SiO₂ layer with a thickness of approximately 95 nm.

15. The information storage medium of claim 14, wherein the information storage medium further comprises a polycarbonate substrate, and the sequential layers are formed over the polycarbonate substrate by sputtering.

16. The information storage medium of claim 13, wherein the reference signal is recorded in recording marks larger than the resolution limit of the incident beam.

17. An information storage medium having recording marks smaller than a resolution limit of an incident beam emitted from an information reproducing apparatus, the information storage medium comprising:
a reference signal recorded in the form of data;
wherein the reference signal is compared to a reproduced signal by the information reproducing apparatus to increase defocus and tilt tolerances.

18. The information storage medium of claim 17, wherein the defocus and tilt tolerances are increased by increasing a power of the incident beam based on a comparison of the reference signal and the reproduced signal.
